(19) United States
(12) Patent Application Publication
(10) Pub. No.: US 2018/0288246 A1
(43) Pub. Date: Oct. 4, 2018

(54) INFORMATION PROCESSING APPARATUS, INFORMATION PROCESSING METHOD, INFORMATION PROCESSING PROGRAM, AND INFORMATION PROCESSING SYSTEM

(71) Applicant: NEC Corporation, Tokyo (JP)

(72) Inventor: Junpei TADA, Tokyo (JP)

(73) Assignee: NEC Corporation, Tokyo (JP)

(21) Appl. No.: 15/915,313

(22) Filed: Mar. 8, 2018

(30) Foreign Application Priority Data
Mar. 30, 2017 (JP) 2017-068442

(51) Int. Cl. H04N 1/00; H04N 5/232; H04N 1/21

(52) U.S. Cl. CPC H04N 1/00214; H04N 5/23203; H04N 2201/0084; H04N 1/2129; H04N 1/00244

(57) ABSTRACT

Data is shared in a secure environment. An information processing apparatus includes a connector. The information processing apparatus also includes an image receiver. In addition, the information processing apparatus includes a storage instructor. The connector of the information processing apparatus performs connection to a specific mobile terminal in response to a connection request from the mobile terminal. The image receiver of the information processing apparatus receives an image captured by the mobile terminal. The storage instructor of the information processing apparatus instructs to store the received image in a specific shared area.

### CROSS-REFERENCE TO RELATED APPLICATION

This application is based upon and claims the benefit of priority from Japanese patent application No. 2017-068442, filed on Mar. 30, 2017, the disclosure of which is incorporated herein in its entirety by reference.

### BACKGROUND OF THE INVENTION

### Field of the Invention

The present invention relates to an information processing apparatus, an information processing method, an information processing program, and an information processing system.

### Description of the Related Art

In the above technical field, patent literature 1 discloses a technique of storing an image captured by a terminal apparatus in an area set as a sharing destination while displaying the captured image on the display unit of an IWB (Interactive White Board) in order to share information among a plurality of users. Patent literature 2 discloses a technique capable of controlling a network shared scanner by activating a scanner driver installed in a server and executing a scan from the server without installing the scanner driver in each of a plurality of clients. Furthermore, patent literature 3 discloses a technique of converting image data into a format transferable by a transfer device, and saving, in a file path allowing transfer by the transfer device, the image data whose format has been converted.
[Patent Literature 1] Japanese Patent Laid-Open No. 2015-041373
[Patent Literature 2] Japanese Patent Laid-Open No. 2011-139341
[Patent Literature 3] Japanese Patent Laid-Open No. 2011-135228

### SUMMARY OF THE INVENTION

In the techniques described in the above literatures, however, it is impossible to share data in a secure environment.

The present invention enables to provide a technique of solving the above-described problem.

One example aspect of the present invention provides an information processing apparatus comprising:

a connector that performs connection to a specific mobile terminal in response to a connection request from the mobile terminal;

an image receiver that receives an image captured by the mobile terminal; and

a storage instructor that instructs to store the received image in a specific shared area.

Another example aspect of the present invention provides an information processing method comprising:

performing connection to a specific mobile terminal in response to a connection request from the mobile terminal;

receiving an image captured by the mobile terminal; and

instructing to store the received image in a specific shared area.

Still other example aspect of the present invention provides an information processing program for causing a computer to execute a method, comprising:
performing connection to a specific mobile terminal in response to a connection request from the mobile terminal;

receiving an image captured by the mobile terminal; and

instructing to store the received image in a specific shared area.

Still other example aspect of the present invention provides an information processing system comprising a mobile terminal and an information processing apparatus,

the mobile terminal including

a connection requester that sends a connection request to the information processing apparatus,

an image capturer that captures an image, and

an image transmitter that transmits the captured image to the connected information processing apparatus, and

the information processing apparatus including

a connector that performs connection to the mobile terminal in response to the connection request from the mobile terminal,

an image receiver that receives the image captured by the mobile terminal, and

a storage instructor that instructs to store the received image in a specific shared area.

According to the present invention, it is possible to share data in a secure environment.

### BRIEF DESCRIPTION OF THE DRAWINGS

FIG. 1 is a block diagram showing the arrangement of an information processing apparatus according to the first example embodiment of the present invention;

FIG. 2 is a view for explaining an outline of an information processing system according to the second example embodiment of the present invention;

FIG. 3 is a block diagram showing the configuration of the information processing system according to the second example embodiment of the present invention;

FIG. 4 is a table showing an example of a storage table held by the information processing apparatus included in the information processing system according to the second example embodiment of the present invention;

FIG. 5 is a block diagram showing the hardware arrangement of the information processing apparatus included in the information processing system according to the second example embodiment of the present invention;

FIG. 6 is a flowchart for explaining the processing procedure of the information processing apparatus included in the information processing system according to the second example embodiment of the present invention;

FIG. 7 is a view for explaining an outline of an information processing system according to the third example embodiment of the present invention;

FIG. 8 is a block diagram showing the configuration of the information processing system according to the third example embodiment of the present invention;

FIG. 9 is a table showing an example of a storage table held by an information processing apparatus included in the information processing system according to the third example embodiment of the present invention;

FIG. 10 is a block diagram showing the hardware arrangement of the information processing apparatus included in the information processing system according to the third example embodiment of the present invention; and

FIG. 11 is a flowchart for explaining the processing procedure of the information processing apparatus included in the information processing system according to the third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

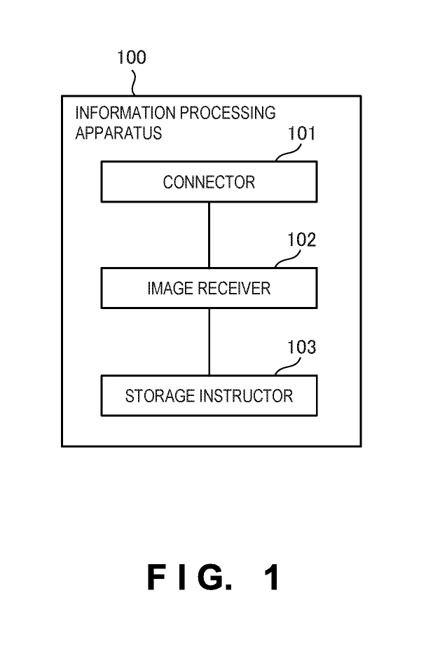

An information processing apparatus 100 according to the first example embodiment of the present invention will be described with reference to FIG. 1. The information processing apparatus 100 is an apparatus that stores a received image in a specific shared area.

As shown in FIG. 1, the information processing apparatus 100 includes a connector 101, an image receiver 102, and a storage instructor 103. The connector 101 performs connection to a specific mobile terminal in response to a connection request from the mobile terminal. The image receiver 102 receives an image captured by the mobile terminal. The storage instructor 103 instructs to store the received image in a specific shared area.

According to this example embodiment, it is possible to share data in a secure environment.

### Second Example Embodiment

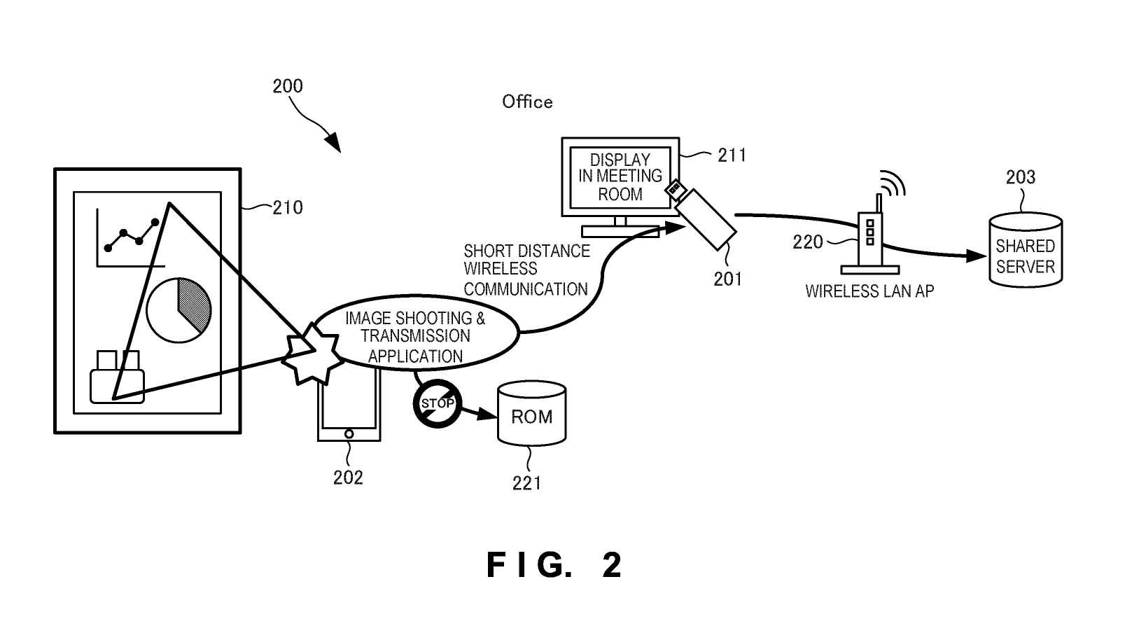

An information processing system according to the second example embodiment of the present invention will be described with reference to FIGS. 2 to 6. FIG. 2 is a view for explaining an outline of an information processing system 200 according to this example embodiment. The information processing system 200 is a system that allows a smart device such as a smartphone for personal use to directly, securely transfer information to a shared server on a closed network such as an in-house network without intervention of the Internet.

Assume, for example, that ideas and decisions are written on a whiteboard or the like in an internal meeting or the like. To leave contents written on a whiteboard after the end of the meeting, there is provided a whiteboard capable of printing the written contents. On the other hand, if the whiteboard has no print function, a meeting participant may record the written contents by shooting them using the camera of an individually owned smartphone or the like.

However, there is no method of securely storing/saving, in an in-house shared server, a photo shot by an individually owned smartphone. That is, it is prohibited to use or pass through a cloud service on the Internet, connect an individually owned (private) device to an in-house wireless LAN, or connect an individually owned device to a PC (Personal Computer) for business use. Thus, there is no method of sharing an image shot by an individually owned smartphone.

In addition, if a meeting participant shoots contents written on a whiteboard by an individually owned smartphone, data of a shot image is recorded in the storage of the individually owned smartphone, thereby posing the risk of information leakage.

The information processing system 200 includes an information processing apparatus 201, a mobile terminal 202, and a shared server 203. Note that in this example embodiment, a USB (Universal Serial Bus) device (USB memory) will be exemplified as the information processing apparatus 201. The information processing apparatus 201 is connected to the USB connector of a display 211 in a meeting room or the like, and operates while being supplied with power.

The user connects the information processing apparatus 201 to the USB connector of the display 211, and activates the information processing apparatus 201. Then, the user activates an application installed in the mobile terminal 202 such as a smartphone. The information processing apparatus 201 is paired with the mobile terminal 202, in which the application has been activated, by short distance wireless communication such as Bluetooth®, thereby establishing connection. Short distance wireless communication may be Wi-Fi, NFC (Near Field Communication), or the like.

An application for performing paring with the information processing apparatus 201 and transmitting an image is downloaded from the information processing apparatus 201 and installed in the mobile terminal 202. The installed application is set to perform connection to the information processing apparatus 201 as a connection destination. Note that the example in which the application is downloaded from the information processing apparatus 201 has been explained. However, the application can be downloaded from the information processing apparatus 201, a dedicated application distribution server, and an application distribution service on a general-purpose cloud. Furthermore, the connection destination of the application can be set after downloading or the application in which a setting is embedded in advance can be downloaded. If the application in which the connection destination has been preset is downloaded, the application is downloaded from the information processing apparatus 201 or the dedicated application distribution server. Alternatively, if the application distribution service on the cloud is used, it is necessary to use it in combination with the provisioning function of the application using an MDM (Mobile Device Management) system. If a connection destination is set after downloading, it is possible to readily make a setting while maintaining security by, for example, a method of pairing the application with the information processing apparatus 201.

After connection between the information processing apparatus 201 and the mobile terminal 202 is established, the user captures a whiteboard or the like used in a meeting using the camera function of the mobile terminal 202 from the activated application. Upon completion of image capturing by the mobile terminal 202, the application of the mobile terminal 202 transmits the captured image to the information processing apparatus 201.

Note that a setting is made so that the image captured by the mobile terminal 202 is stored in the temporary storage memory of the mobile terminal 202 or the like but, after the application transfers the image to the information processing apparatus 201, the transferred image is deleted from the temporary storage memory. Alternatively, the application of the mobile terminal 202 is set to delete a transmitted image without saving it in the internal memory of the mobile terminal 202.

Note that the information processing apparatus 201 is set not to receive files and data other than image files and image data transmitted from the application installed in the mobile terminal 202.

Upon receiving the image from the mobile terminal 202, the information processing apparatus 201 stores the received image in a preset specific shared area of the shared server 203. A specific shared area is set in accordance with, for example, a department, group, or position in a company. However, a method of setting a specific shared area is not limited to this.

The information processing apparatus 201 and the shared server 203 are connected via, for example, a wireless LAN (Local Area Network), and data of the image received by the information processing apparatus 201 is transferred to the shared server 203 via a wireless LAN AP (Access Point) 220. Note that the information processing apparatus 201 and the shared server 203 may be connected by a wired LAN, a USB cable, or the like.

Every time an image is received, the information processing apparatus 201 may store the image in the shared server 203. If a predetermined data amount or a predetermined number of images are accumulated, the information processing apparatus 201 may store the accumulated images in the shared server 203 or the user may instruct to store the images at an arbitrary timing. After the images are stored in the shared server 203, data of the accumulated images are deleted by the application. Note that the data of the images may be deleted by an instruction from the information processing apparatus 201.

Note that the example in which the image data is shared has been explained. However, the shared data is not limited to the image data, and may be, for example, text data, video data, or another data.

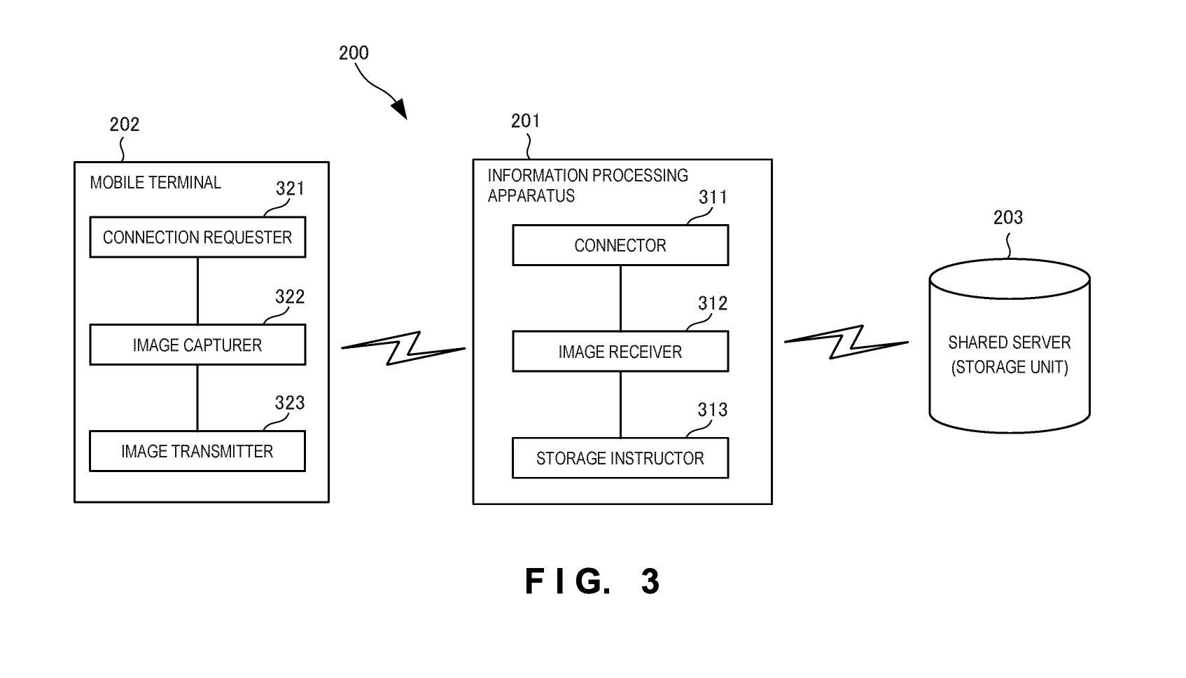

FIG. 3 is a block diagram showing the configuration of the information processing system 200 according to this example embodiment. The information processing system 200 includes the information processing apparatus 201, the mobile terminal 202, and the shared server (storage unit) 203.

The information processing apparatus 201 includes a connector 311, an image receiver 312, and a storage instructor 313. The connector 311 performs connection to the specific mobile terminal 202 in response to a connection request from the mobile terminal 202. The specific mobile terminal 202 is a mobile terminal in which an application for transmitting a captured image to the information processing apparatus 201 has been activated. The information processing apparatus 201 is connected to the mobile terminal 202 by short distance wireless communication such as Bluetooth®.

The image receiver 312 receives the image transmitted from the mobile terminal 202. That is, the image receiver 312 receives data of an image transmitted from the specific mobile terminal 202 in which the application has been activated, and receives no files or data other than the data of the image. Note that the present invention is not limited to this if the application or the information processing apparatus 201 is permitted to transmit or receive data and files other than image data and image files.

The storage instructor 313 instructs the shared server 203 to store the received image in a specific shared area of the shared server 203. A specific shared area may be determined in accordance with, for example, the identifier (ID) of the application activated in the mobile terminal 202 or the department or position of the owner of the mobile terminal 202.

The mobile terminal 202 includes a connection requester 321, an image capturer 322, and an image transmitter 323. The connection requester 321 sends a connection request to the information processing apparatus 201. The mobile terminal 202 and the information processing apparatus 201 are paired by short distance wireless communication such as Bluetooth® to establish connection. More specifically, the connection requester 321 sets the mobile terminal 202 in a searchable state. The information processing apparatus 201 searches for the mobile terminal 202 to establish connection to the mobile terminal 202. Note that once the information processing apparatus 201 and the mobile terminal 202 are paired, connection is established automatically or semiautomatically from the next time.

The image capturer 322 captures an image. The image capturer 322 is a camera incorporated in the mobile terminal 202, or the like. For example, the owner of the mobile terminal 202 activates the application installed in the mobile terminal 202, and captures an image of a whiteboard in a meeting room or the like using the image capturer 322 such as the camera incorporated in the mobile terminal 202.

The image transmitter 323 transmits the image of the whiteboard or the like captured by the image capturer 322 to the information processing apparatus 201 connected to the mobile terminal 202.

A specific shared area is allocated to the shared server 203. The shared server 203 stores the image in the specific shared area in accordance with an instruction of the storage instructor 313. The specific shared area is set for, for example, each application installed in the mobile terminal 202 or each department or class of the owner of the mobile terminal 202. However, a method of setting a shared area is not limited to this. Note that the information processing apparatus 201 and the shared server 203 are connected by the wireless LAN but may be connected by a wired LAN.

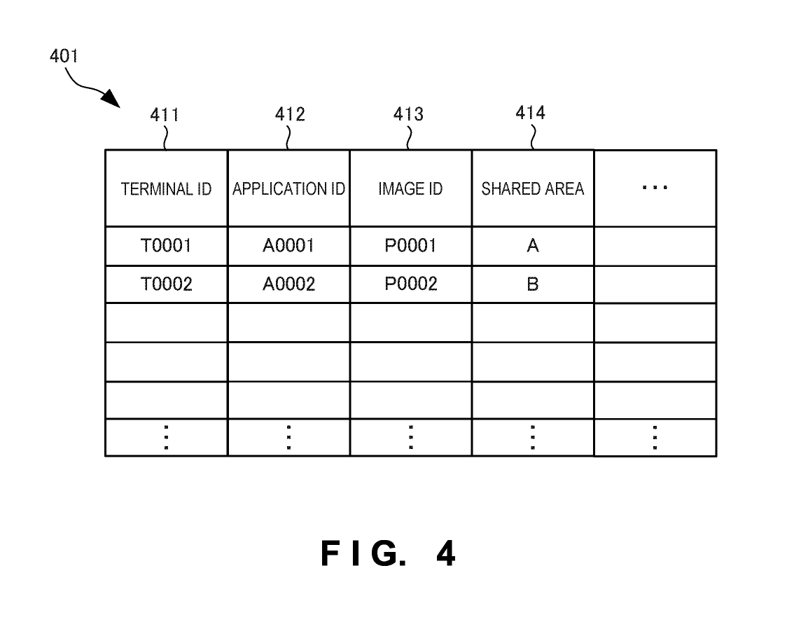

FIG. 4 is a table showing an example of a storage table 401 held by the information processing apparatus 201 included in the information processing system 200 according to this example embodiment. The storage table 401 stores an application ID 412, an image ID 413, and a shared area 414 in association with a terminal ID 411.

The terminal ID 411 is an identifier for identifying the mobile terminal 202 or the like. The application ID 412 is an identifier for identifying an application installed in the mobile terminal 202. The image ID 413 is an identifier for identifying an image captured by the mobile terminal 202. The shared area 414 indicates the memory location of the image captured by the mobile terminal 202. The information processing apparatus 201 stores the image captured by the mobile terminal 202 in the shared area of the shared server 203 with reference to, for example, the storage table 401.

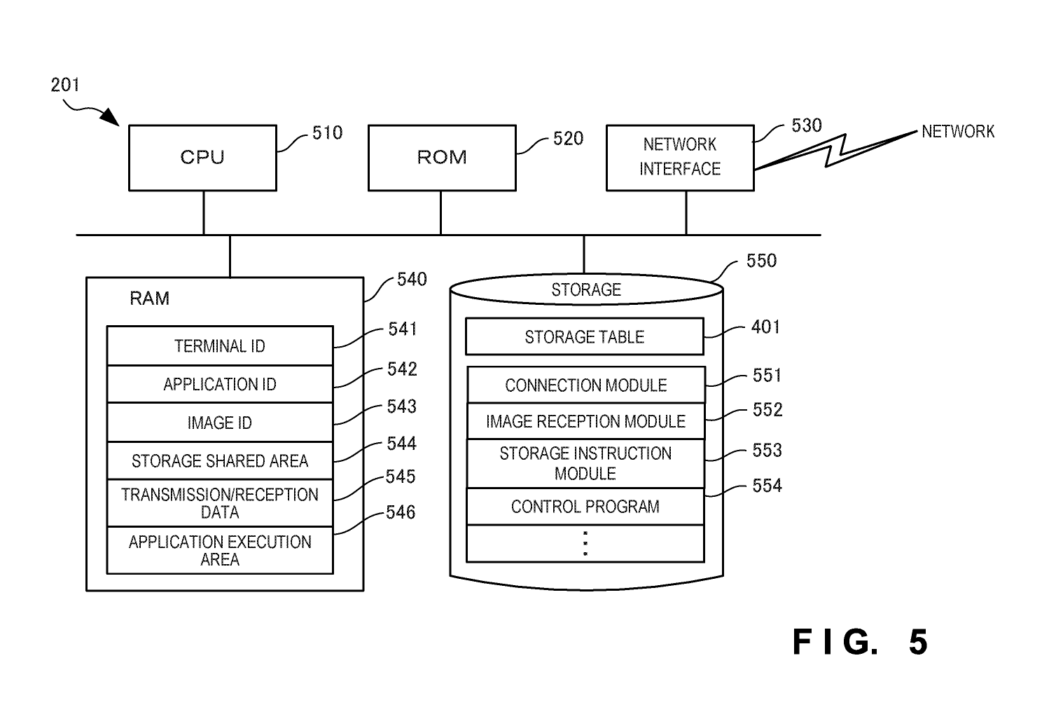

FIG. 5 is a block diagram for explaining the hardware arrangement of the information processing apparatus 201 included in the information processing system according to this example embodiment. A CPU (Central Processing Unit) 510 is an arithmetic control processor, and implements the functional components of the information processing apparatus 201 shown in FIG. 3 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus or the like via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads transmission/reception data in or from the area of a RAM (Random Access Memory) 540. It is desirable to provide a DMAC (Direct Memory Access Controller) (not shown) for transferring data between the RAM 540 and a storage 550. Furthermore, the CPU 510 recognizes that data has been received by the RAM 540 or transferred to the RAM 540, and processes the data. The CPU 510 prepares a processing result in the RAM 540, and delegates succeeding transmission or transfer to the network interface 530 or DMAC.

The RAM 540 is a random access memory used as a temporary storage work area by the CPU 510. An area to store data necessary for implementation of the example embodiment is allocated to the RAM 540. A terminal ID 541 is data for identifying the mobile terminal 202 connected to the information processing apparatus 201. An application ID 542 is data for identifying an application installed in the mobile terminal 202 and activated. An image ID 543 is data for identifying an image captured by the mobile terminal 202. A storage shared area 544 is data indicating a specific shared area of the shared server 203 in which the image received from the mobile terminal 202 is stored. These data are deployed from, for example, the storage table 401.

Transmission/reception data 545 is data transmitted/received via the network interface 530. The RAM 540 includes an application execution area 546 used to execute various application modules.

The storage 550 stores a database, various parameters, or the following data or programs necessary for implementation of the example embodiment. The storage 550 stores the storage table 401. The storage table 401 is a table, shown in FIG. 4, for managing the relationship among the terminal ID 411, the shared area 414, and the like.

The storage 550 also stores a connection module 551, an image reception module 552, and a storage instruction module 553.

The connection module 551 is a module that connects the information processing apparatus 201 and the mobile terminal 202 in response to a connection request from the mobile terminal 202. The image reception module 552 is a module that receives an image captured by the mobile terminal 202 and transmitted to the information processing apparatus 201. The storage instruction module 553 is a module that instructs to store the received image in the specific shared area. These modules 551 to 553 are loaded into the application execution area 546 of the RAM 540 by the CPU 510, and executed. A control program 554 is a program that controls the overall information processing apparatus 201.

Note that programs and data that are associated with the general-purpose functions of the information processing apparatus 201 and other feasible functions are not shown in the RAM 540 or the storage 550 of FIG. 5.

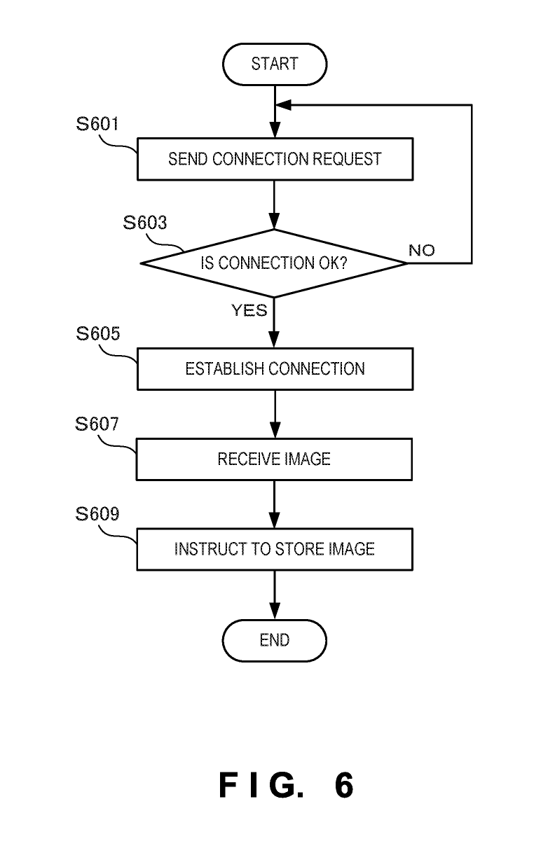

FIG. 6 is a flowchart for explaining the processing procedure of the information processing apparatus 201 according to this example embodiment. This flowchart is executed by the CPU 510 of FIG. 5 using the RAM 540, thereby implementing the functional components of the information processing apparatus 201 shown in FIG. 3.

In step S601, the information processing apparatus 201 receives a connection request from the mobile terminal 202. In step S603, the information processing apparatus 201 determines whether to permit the connection request from the mobile terminal 202. The information processing apparatus 201 determines permission/rejection of the connection request based on whether the mobile terminal 202 that has sent the connection request is a specific mobile terminal, that is, a mobile terminal in which a predetermined application has been installed. If the connection request is rejected (NO in step S603), the information processing apparatus 201 returns to step S601. If the connection request is permitted (YES in step S603), the information processing apparatus 201 advances to step S605.

In step S605, the information processing apparatus 201 establishes connection to the mobile terminal 202 that has sent the connection request. In step S607, the information processing apparatus 201 receives an image transmitted from the mobile terminal 202. In step S609, the information processing apparatus 201 instructs to store the received image in the specific shared area of the shared server 203.

According to this example embodiment, it is possible to share data in a secure environment. Even an individually owned smartphone can directly, securely transfer information to the in-house shared server without intervention of the Internet. Furthermore, since image data stored in the shared server is deleted from the individually owned smartphone, it is possible to largely reduce the possibility of information leakage.

### Third Example Embodiment

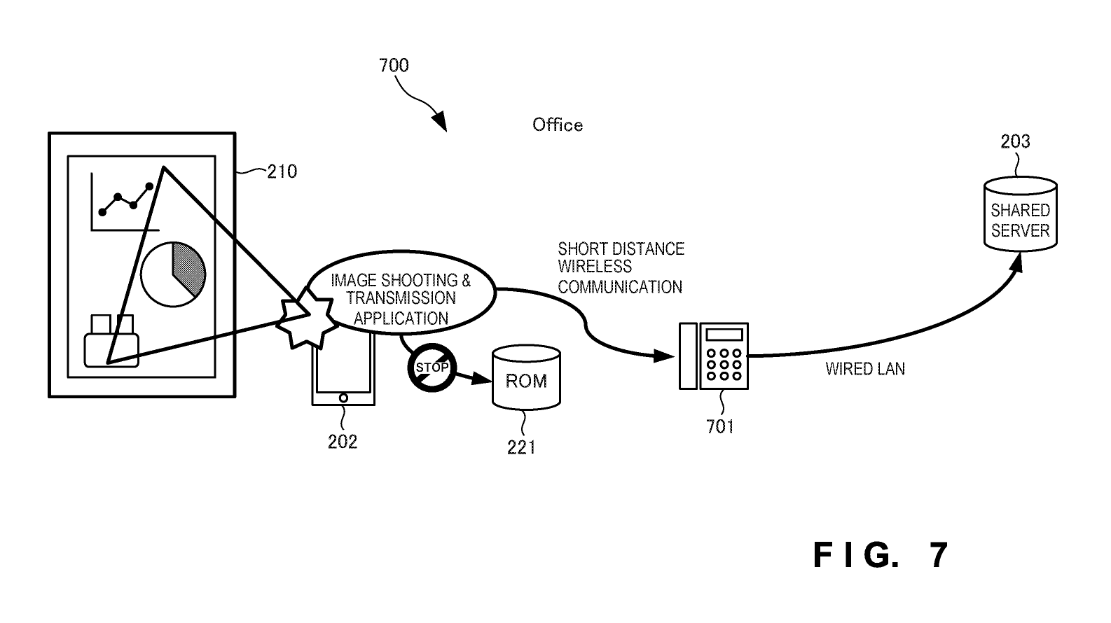

An information processing system according to the third example embodiment of the present invention will be described next with reference to FIGS. 7 to 11. FIG. 7 is a view for explaining an outline of an information processing system 700 according to this example embodiment. The information processing system 700 according to this example embodiment is different from that according to the above-described second example embodiment in that an information processing apparatus 701 is incorporated in a telephone existing in an office space, and the telephone is connected to a shared server by a wired LAN. In addition, the information processing apparatus 701 includes an image capturing controller. The remaining components and operations are the same as those in the second example embodiment. Hence, the same reference numerals denote the same components and operations, and a detailed description thereof will be omitted.

The information processing system 700 includes a mobile terminal 202, a shared server 203, and the information processing apparatus 701 incorporated in each of telephones as devices existing at a predetermined interval in the office space. The information processing apparatus 701 is connected to the mobile terminal 202 by short distance wireless communication to receive an image captured by the mobile terminal 202 and instruct to store the received image in a specific shared area of the shared server 203. Note that the information processing apparatus 701 has been explained by exemplifying the telephones as the devices existing at the predetermined interval in the office space. However, the devices are not limited to the telephones, and may be, for example, displays, light switches, or air conditioning switches. The information processing apparatus 701 may be the USB device described in the second example embodiment.

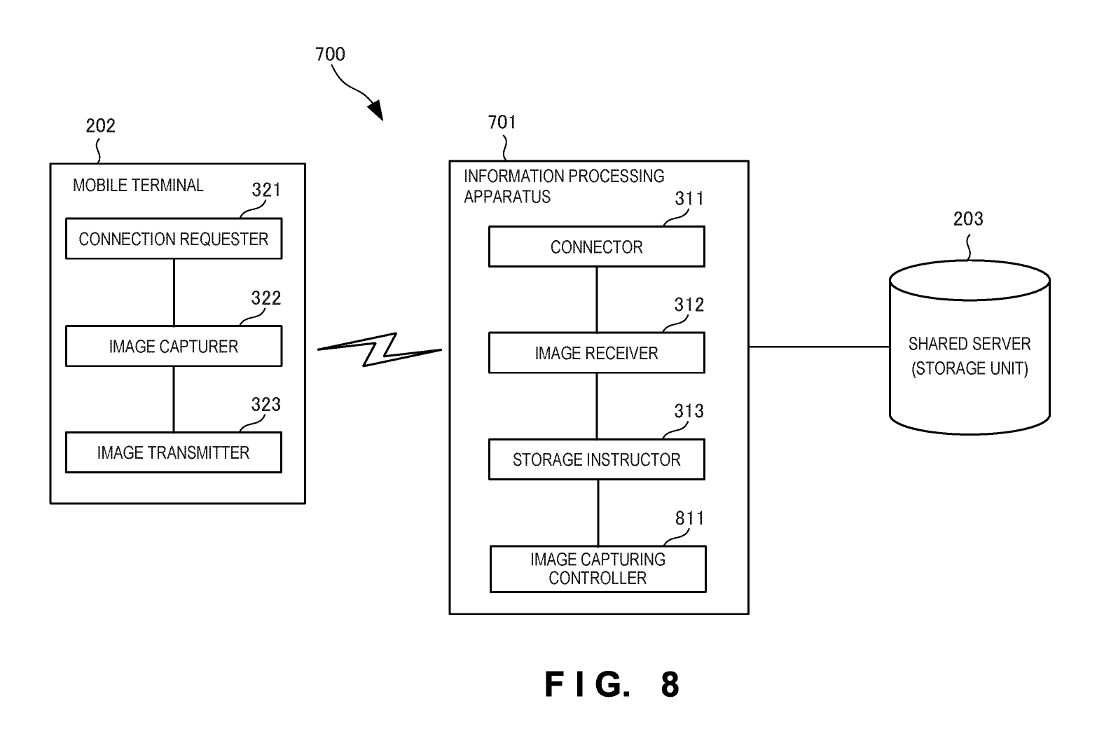

FIG. 8 is a block diagram showing the configuration of the information processing system 700 according to this example embodiment. The information processing system 700 includes the information processing apparatus 701, the mobile terminal 202, and the shared server 203. The information processing apparatus 701 and the mobile terminal 202 are paired by short distance wireless communication such as Bluetooth® to establish connection. The information processing apparatus 701 and the shared server 203 are connected by the wired LAN but may be connected by a wireless LAN.

The information processing apparatus 701 additionally includes an image capturing controller 811. The image capturing controller 811 outputs an image capturing control signal to the mobile terminal 202. Upon receiving the image capturing control signal, the mobile terminal 202 captures an image in accordance with the image capturing control signal.

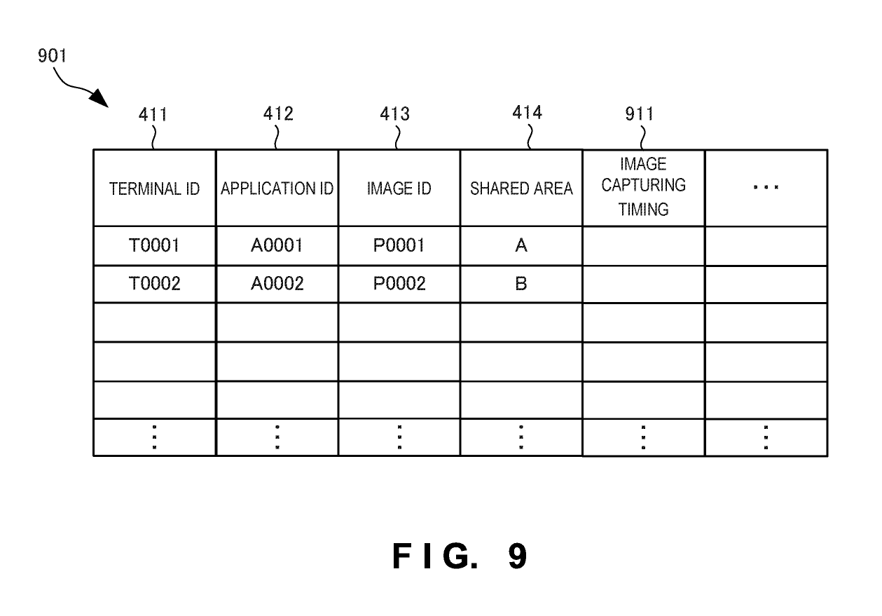

FIG. 9 is a table showing an example of a storage table 901 held by the information processing apparatus 701 included in the information processing system 700 according to this example embodiment. The storage table 901 stores an image capturing timing 911 in association with a terminal ID 411. The image capturing timing 911 indicates a timing of capturing an image after the mobile terminal 202 receives the image capturing control signal from the information processing apparatus 701. The image capturing timing 911 indicates a timing of capturing an image immediately after receiving the image capturing control signal, a timing of capturing an image after a predetermined time elapses since the image capturing control signal is received, or the like. The present invention, however, is not limited to them. The information processing apparatus 701 controls image capturing by the mobile terminal 202 with reference to the storage table 901.

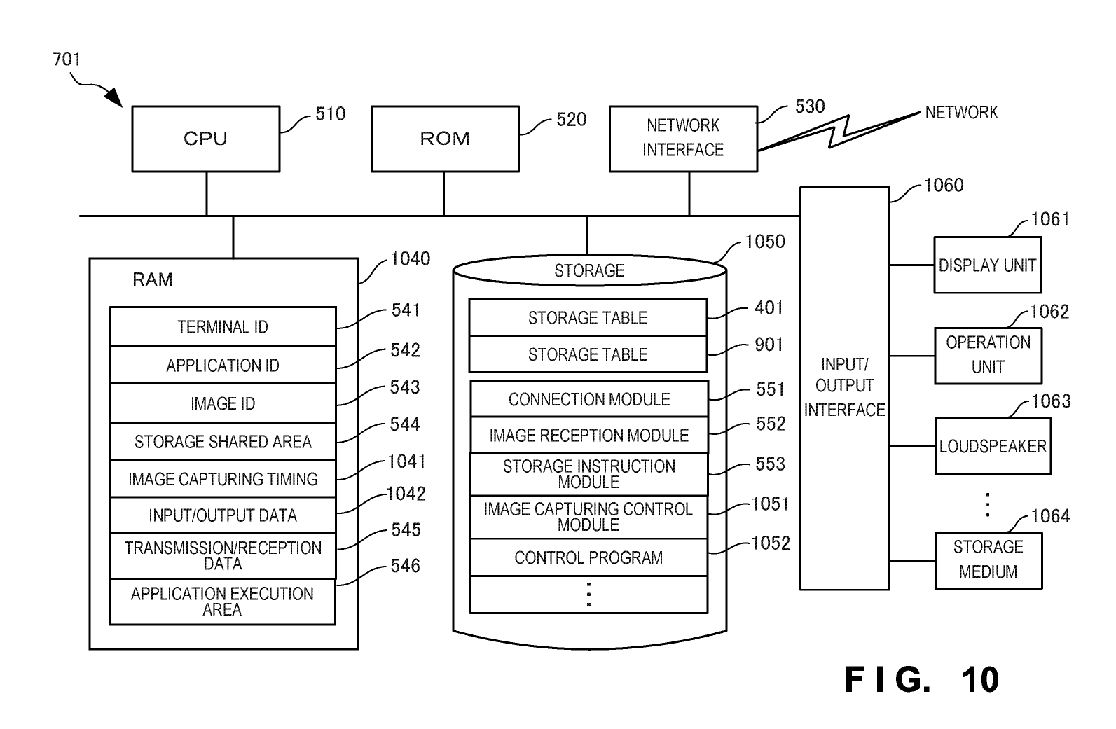

FIG. 10 is a block diagram showing the hardware arrangement of the information processing apparatus 701 included in the information processing system 700 according to this example embodiment. A CPU (Central Processing Unit) 510 is an arithmetic control processor, and implements the functional components of the information processing apparatus 701 shown in FIG. 8 by executing a program. The CPU 510 may include a plurality of processors to parallelly execute different programs, modules, tasks, or threads. A ROM (Read Only Memory) 520 stores permanent data such as initial data and a program, and other programs. A network interface 530 communicates with another apparatus or the like via a network. Note that the number of CPUs 510 is not limited to one, and a plurality of CPUs or a GPU (Graphics Processing Unit) for image processing may be included. The network interface 530 desirably includes a CPU independent of the CPU 510, and writes or reads transmission/reception data in or from the area of a RAM (Random Access Memory) 1040. It is desirable to provide a DMAC (Direct Memory Access Controller) (not shown) for transferring data between the RAM 1040 and a storage 1050. Furthermore, an input/output interface 1060 desirably includes a CPU independent of the CPU 510, and writes or reads input/output data in or from the area of the RAM 1040. Therefore, the CPU 510 recognizes that data has been received by the RAM 1040 or transferred to the RAM 1040, and processes the data. The CPU 510 prepares a processing result in the RAM 1040, and delegates succeeding transmission or transfer to the network interface 530, DMAC, or input/output interface 1060.

The RAM 1040 is a random access memory used as a temporary storage work area by the CPU 510. An area to store data necessary for implementation of the example embodiment is allocated to the RAM 1040. An image capturing timing 1041 is data indicating a timing of capturing an image after the mobile terminal 202 receives the image capturing control signal. This data is deployed from, for example, the storage table 901. Input/output data 1042 is data input/output via the input/output interface 1060.

The storage 1050 stores a database, various parameters, or the following data or programs necessary for implementation of the example embodiment. The storage 1050 also stores the storage table 901. The storage table 901 is a table, shown in FIG. 9, for managing the relationship among the terminal ID 411, the image capturing timing 911, and the like.

The storage 1050 also stores an image capturing control module 1051. The image capturing control module 1051 is a module that controls image capturing by the mobile terminal 202 by outputting an image capturing control signal to the mobile terminal 202. This module 1051 is loaded into an application execution area 546 of the RAM 1040 by the CPU 510, and executed. A control program 1052 is a program that controls the overall information processing apparatus 701.

The input/output interface 1060 interfaces input/output data with an input/output device. The input/output interface 1060 is connected to a display unit 1061 and an operation unit 1062. The input/output interface 1060 may also be connected to a storage medium 1064. Furthermore, a loudspeaker 1063 serving as a voice output unit, a microphone (not shown) serving as a voice input unit, or a GPS position determiner may be connected. Note that programs and data that are associated with the general-purpose functions of the information processing apparatus 701 and other feasible functions are not shown in the RAM 1040 or the storage 1050 of FIG. 10.

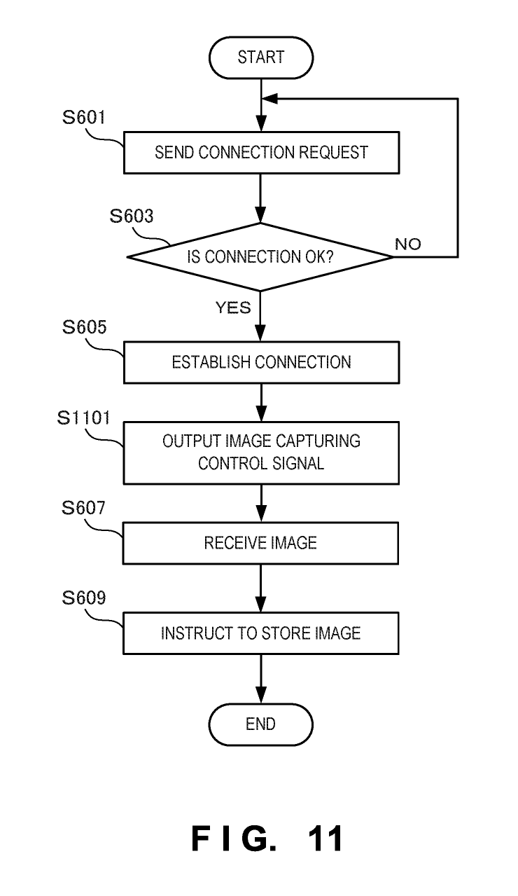

FIG. 11 is a flowchart for explaining the processing procedure of the information processing apparatus 701 according to this example embodiment. This flowchart is executed by the CPU 510 of FIG. 10 using the RAM 1040, thereby implementing the functional components of the information processing apparatus 701 shown in FIG. 8.

In step S1101, the information processing apparatus 701 outputs an image capturing control signal to the mobile terminal 202.

According to this example embodiment, since the devices existing at the predetermined interval in the office space are used, it is possible to more readily store an image captured by an individually owned smartphone in a shared area in a secure environment.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of the example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described example embodiments can also be described as in the following supplementary notes but are not limited to the followings.

### (Supplementary Note 1)

There is provided an information processing apparatus comprising:

a connector that performs connection to a specific mobile terminal in response to a connection request from the mobile terminal;

an image receiver that receives an image captured by the mobile terminal; and

a storage instructor that instructs to store the received image in a specific shared area.

### (Supplementary Note 2)

There is provided the apparatus according to supplementary note 1, wherein the specific mobile terminal is a mobile terminal in which an application for transmitting the captured image to the information processing apparatus has been activated.

### (Supplementary Note 3)

There is provided the apparatus according to supplementary note 1 or 2, wherein the connector performs connection to the mobile terminal by short distance wireless communication.

### (Supplementary Note 4)

There is provided the apparatus according to any one of supplementary notes 1 to 3, wherein the storage instructor instructs to store the received image in the specific shared area of a storage unit connected via a wire or wirelessly.

### (Supplementary Note 5)

There is provided the apparatus according to any one of supplementary notes 1 to 4, wherein the information processing apparatus comprises a USB device.

### (Supplementary Note 6)

There is provided the apparatus according to any one of supplementary notes 1 to 4, wherein the information processing apparatus is included in each of devices existing at a predetermined interval in an office space or incorporated in each of devices existing at a predetermined interval in an office space.

### (Supplementary Note 7)

There is provided the apparatus according to supplementary note 6, wherein the device includes at least one of a display, a telephone, a light switch, and an air conditioning switch.

### (Supplementary Note 8)

There is provided the apparatus according to any one of supplementary notes 1 to 7, further comprising an image capturing controller that outputs an image capturing control signal to the mobile terminal.

### (Supplementary Note 9)

There is provided an information processing method comprising:

performing connection to a specific mobile terminal in response to a connection request from the mobile terminal;

receiving an image captured by the mobile terminal; and

instructing to store the received image in a specific shared area.

### (Supplementary Note 10)

There is provided an information processing program for causing a computer to execute a method, comprising:

performing connection to a specific mobile terminal in response to a connection request from the mobile terminal;

receiving an image captured by the mobile terminal; and

instructing to store the received image in a specific shared area.

### (Supplementary Note 11)

There is provided an information processing system comprising a mobile terminal and an information processing apparatus,

the mobile terminal including

a connection requester that sends a connection request to the information processing apparatus,

an image capturer that captures an image, and

an image transmitter that transmits the captured image to the connected information processing apparatus, and

the information processing apparatus including

a connector that performs connection to the mobile terminal in response to the connection request from the mobile terminal,

an image receiver that receives the image captured by the mobile terminal, and

a storage instructor that instructs to store the received image in a specific shared area.

What is claimed is:

1. An information processing apparatus comprising:
a connector that performs connection to a specific mobile terminal in response to a connection request from the mobile terminal;
an image receiver that receives an image captured by the mobile terminal; and
a storage instructor that instructs to store the received image in a specific shared area.

2. The apparatus according to claim 1, wherein the specific mobile terminal is a mobile terminal in which an application for transmitting the captured image to the information processing apparatus has been activated.

3. The apparatus according to claim 1, wherein said connector performs connection to the mobile terminal by short distance wireless communication.

4. The apparatus according to claim 1, wherein said storage instructor instructs to store the received image in the specific shared area of a storage unit connected via a wire or wirelessly.

5. The apparatus according to claim 1, wherein the information processing apparatus comprises a USB device.

6. The apparatus according to claim 1, wherein the information processing apparatus is included in each of devices existing at a predetermined interval in an office space or incorporated in each of devices existing at a predetermined interval in an office space.

7. The apparatus according to claim 1, further comprising an image capturing controller that outputs an image capturing control signal to the mobile terminal.

8. There is provided the apparatus according to claim 6, wherein the device includes at least one of a display, a telephone, a light switch, and an air conditioning switch.

9. An information processing method comprising:
performing connection to a specific mobile terminal in response to a connection request from the mobile terminal;
receiving an image captured by the mobile terminal; and
instructing to store the received image in a specific shared area.

10. The information processing method according to claim 9, wherein the specific mobile terminal is a mobile terminal in which an application for transmitting the captured image to the information processing apparatus has been activated.

11. The information processing method according to claim 9, further comprising performing connection to the mobile terminal by short distance wireless communication.

12. The information processing method according to claim 9, further comprising instructing to store the received image in the specific shared area of a storage unit connected via a wire or wirelessly.

13. The information processing method according to claim 9, wherein the information processing apparatus comprises a USB device.

14. The information processing method according to claim 9, wherein the information processing apparatus is included in each of devices existing at a predetermined interval in an office space or incorporated in each of devices existing at a predetermined interval in an office space.

15. The information processing method according to claim 9, further comprising outputting an image capturing control signal to the mobile terminal.

16. A non-transitory computer readable medium storing an information processing program for causing a computer to execute a method, comprising:
performing connection to a specific mobile terminal in response to a connection request from the mobile terminal;
receiving an image captured by the mobile terminal; and
instructing to store the received image in a specific shared area.

17. The apparatus according to claim 2, wherein said connector performs connection to the mobile terminal by short distance wireless communication.

18. The apparatus according to claim 17, wherein said storage instructor instructs to store the received image in the specific shared area of a storage unit connected via a wire or wirelessly.

19. The apparatus according to claim 18, wherein the information processing apparatus comprises a USB device.

20. The apparatus according to claim 19, wherein the information processing apparatus is included in each of devices existing at a predetermined interval in an office space or incorporated in each of devices existing at a predetermined interval in an office space.
